(19) United States
(12) Patent Application Publication
(10) Pub. No.: US 2010/0236354 A1
(43) Pub. Date: Sep. 23, 2010

(54) CAM MECHANISM HAVING A CONTROL CAM AND A CONTROL ROLLER, ALIGNMENT CYLINDER AND SHEET PROCESSING MACHINE

(75) Inventors: Andreas Müller, Heidelberg (DE); Burkhard Wolf, Dossenheim (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AG, Heidelberg (DE)

(21) Appl. No.: 12/728,349

(22) Filed: Mar. 22, 2010

(30) Foreign Application Priority Data
Mar. 20, 2009 (DE) 10 2009 014 058.1

(51) Int. Cl. F16H 53/06

(52) U.S. Cl. 74/569

(57) ABSTRACT

A cam mechanism includes a control cam and a control roller rolling on the control cam to produce a deflection of the control roller. The control cam and the control roller each have a respective anti-twist safeguard, protection or device interacting with each other and being constructed, for example, as a toothing system. An alignment cylinder for sheets and a sheet processing machine are also provided.

### CROSS-REFERENCE TO RELATED APPLICATION

This application claims the priority, under 35 U.S.C. § 119, of German Patent Application DE 10 2009 014 058.1, filed Mar. 20, 2009; the prior application is herewith incorporated by reference in its entirety.

### BACKGROUND OF THE INVENTION

### Field of the Invention

The invention relates to a cam mechanism for producing a deflection, stroke or travel of a control roller rolling on a control cam.

Since, in a control cam-control roller mechanism, it is primarily a matter of the control roller experiencing a deflection resulting from the control contour of the control cam, it is normally completely sufficient if the control roller has a relatively small circumference in relation to the control cam and the circumference or the length of the control cam is an integer multiple of the circumference of the control roller, in order to achieve reproducible results with a satisfactory accuracy.

In a cam mechanism for actuating a pregripper in a sheet processing machine, which is known from German Patent DE 43 16 599 C2, corresponding to U.S. Pat. No. 5,544,546, a rotating control cam interacts with a control roller disposed on the pregripper.

In that case, the circumference of the control cam is an integer multiple of the circumference of the control roller.

However, in devices of that type, as a result of fabrication inaccuracies, circularity errors or slippage, it is possible for the point of contact between the control cam and the control roller to vary, in particular in the two “sheet acceptance” and “sheet transfer” functional positions of the pregripper, as a result of a rotational angle offset between the control cam and the control roller.

### SUMMARY OF THE INVENTION

It is accordingly an object of the invention to provide a cam mechanism having a control cam and a control roller, an alignment cylinder and a sheet processing machine, which overcome the hereinafore-mentioned disadvantages of the heretofore-known devices of this general type and which avoid any rotational angle offset between a control cam and a control roller, in particular in the area of the functional positions.

With the foregoing and other objects in view there is provided, in accordance with the invention, a cam mechanism, comprising a control cam, and a control roller rolling on the control cam to produce a deflection of the control roller. The control cam and the control roller each have a respective anti-twist safeguard, protection or device interacting with each other.

It is a particular advantage of the invention that the control cam has an anti-twist safeguard, protection or device with respect to the control roller, in particular in the area of functional positions. As a result of this measure, a point of contact between the control cam and the control roller in the area of the functional positions can be reproduced unambiguously. In this way, circularity errors, fabrication tolerances, slippage and play in the bearings remain constant and thus without any influence.

In a preferred embodiment, provision is made for the control cam and the control roller to each have an intermeshing toothing system. This can preferably be disposed in each case parallel to the running surface of the control cam and the control roller.

Other features which are considered as characteristic for the invention are set forth in the appended claims.

Although the invention is illustrated and described herein as embodied in a cam mechanism having a control cam and a control roller, an alignment cylinder and a sheet processing machine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal-sectional view of a sheet processing machine, in particular a printing press;

FIG. 2 is an enlarged, fragmentary longitudinal-sectional view of a feed cylinder having a toothed cam drive according to the invention for front lays;

FIG. 3 is a fragmentary, plan view of a cam mechanism according to the invention having a toothed ring-gear wheel anti-twist safeguard, protection or device;

FIG. 4 is a front-elevational view of a further exemplary embodiment having a chain-sprocket anti-twist safeguard, protection or device;

FIGS. 5A and 5B are respective front-elevational and side-elevational views of a further exemplary embodiment having a pin wheel anti-twist safeguard, protection or device; and

FIGS. 6A and 6B are respective front-elevational and side-elevational views of a further exemplary embodiment having a driver-stop anti-twist safeguard, protection or device.

### DETAILED DESCRIPTION OF THE INVENTION

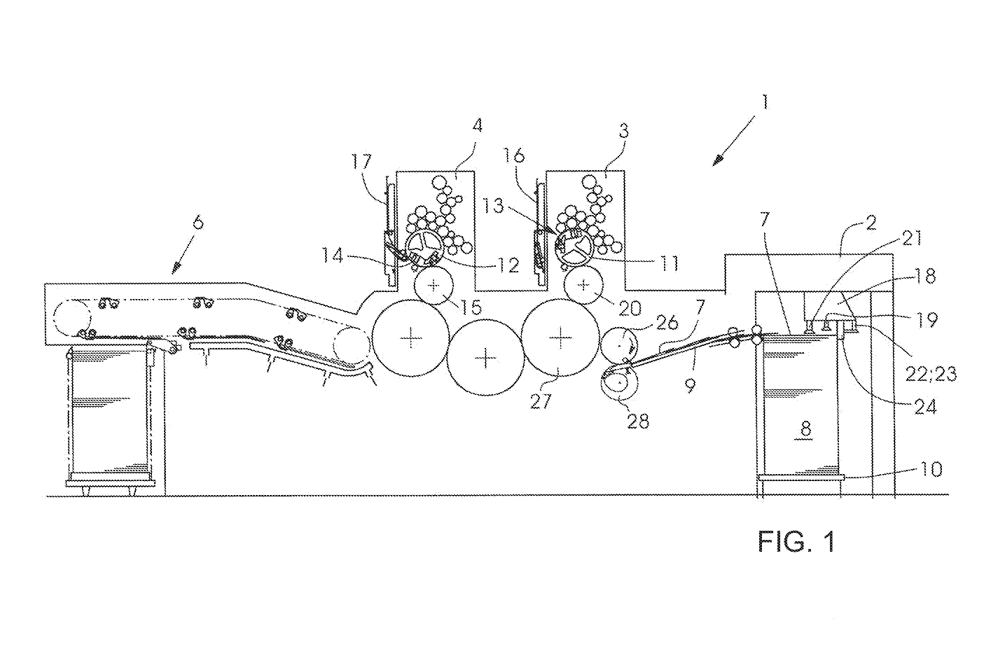

Referring now to the figures of the drawings in detail and first, particularly, to FIG. 1 thereof, there is seen a machine, for example a printing press 1, for processing sheets 7, having a feeder 2, at least one printing unit 3, 4 and a delivery 6. The sheets 7 are taken from a sheet stack 8 and, separated or in overlapping formation, are fed over a feed table 9 to the printing units 3, 4. The latter each contain, in a known manner, a plate cylinder 11, 12 and a blanket cylinder 15, 20 interacting therewith in each case. The plate cylinders 11, 12 each have a clamping and tensioning apparatus 13, 14 for fixing flexible printing plates. Furthermore, each plate cylinder 11, 12 is assigned an apparatus 16, 17 for semiautomatic or fully automatic printing plate change.

The sheet stack 8 rests on a stack board 10 that can be raised under control. The removal of the sheets 7 is carried out from the top of the sheet stack 8 through the use of a so-called suction head 18 which, amongst other things, has a number of lifting and dragging suckers 19, 21 for separating the sheets 7. Moreover, blowing devices 22 are provided in order to loosen the upper sheet layers, as are sensing elements 23 for stack tracking. A number of side and rear stops 24 are provided in order to align the sheet stack 8, in particular the upper sheets 7 of the sheet stack 8.

At the end of the feed table 9 which, in particular, is a suction belt table, there is disposed a printing unit cylinder, e.g. a feed cylinder 26, which grips the sheets 7 at their leading edge and transfers them to a downstream cylinder 27, for example an impression cylinder.

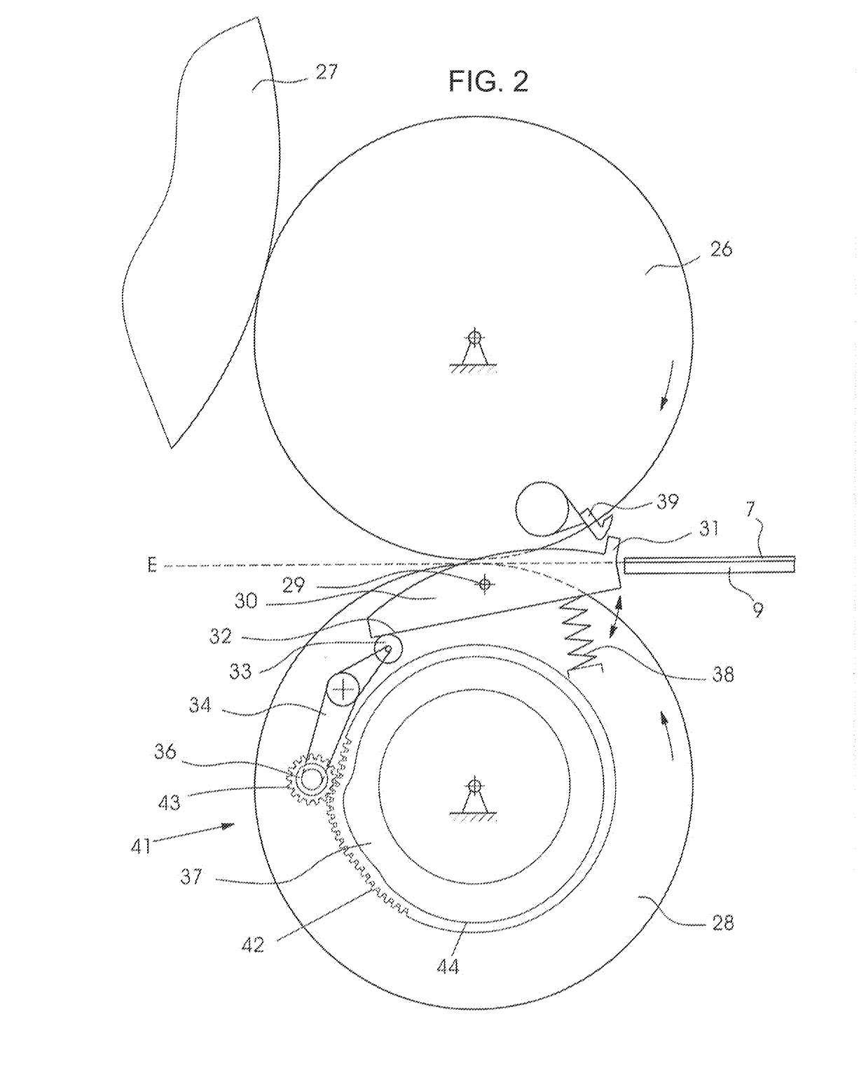

As is seen in FIG. 2, an alignment cylinder 28, which is driven at the speed of the feed cylinder 26, is provided underneath the feed cylinder 26, approximately tangentially to a feed plane E formed by the feed table 9. A number of front lay supports 30 having front lay stops 31 are disposed on a common pivot shaft 29, spaced apart from one another transversely with respect to the sheet transport direction. The pivot shaft 29 is pivotably mounted on the cylinder body of the alignment cylinder 28.

A respective stop 32 is provided at an end of each front lay support 30, which is opposite the front lay stop 31, for a mating stop formed as a roller 33. The mating stop 33 is seated in such a way that it can rotate at a first end of a double-armed cam lever 34, which is pivotably mounted on the alignment cylinder 28. A control roller 36 of a cam mechanism 41 is mounted so as to continue to rotate about its rotational axis on a second end of the double-armed lever 34. The control roller 36, which is disposed so as to be stationary, is in operative contact with a contour of a control cam 37 of the cam mechanism 41. A compression spring 38, which is supported on the alignment cylinder 28, presses with prestress on the front lay support 30, so that the front lay 31 is pivoted out of the periphery of the alignment cylinder 28 under the force of the spring 38. In this case, the control roller 33 is in continuous contact with the stop 32 of the front lay support 30 and controls the movement of the front lay 31.

In order to align a leading sheet edge, the front lays 31 are pivoted out of the periphery of the alignment cylinder 28 as far as the plane E. Through the use of transport systems disposed on the feed table 9, for example a suction belt, the sheet 7 is conveyed towards the front lays 31 at a speed V₁ which is greater than a speed V₂ of the front lays 31 in the sheet transport direction. In this case, the sheet 7 is aligned in the sheet transport direction and with respect to a skewed position.

Following the completion of the alignment phase, the sheet is picked up by transport grippers 39 of the feed cylinder 26. A speed V₃ of the transport grippers 39 is then synchronized with the speed V₂ of the stops, that is to say the speeds V₂=V₃ at the time of closure of the grippers 39.

During the alignment phase, the front lays 31 are moved translationally along an imaginary extension—plane E—of the feed table 9. The sheet is aligned in the transport direction and also with respect to a skewed position on the front lays 31 during the alignment phase and is then gripped by the transport grippers 39 of the feed cylinder 26. Following the closure of the transport grippers 39, the front lays 31 dip into the periphery of the alignment cylinder 28, until, shortly before reaching the plane E, they are pivoted out of the periphery of the alignment cylinder 28 into the plane E in order to align the next sheet 7.

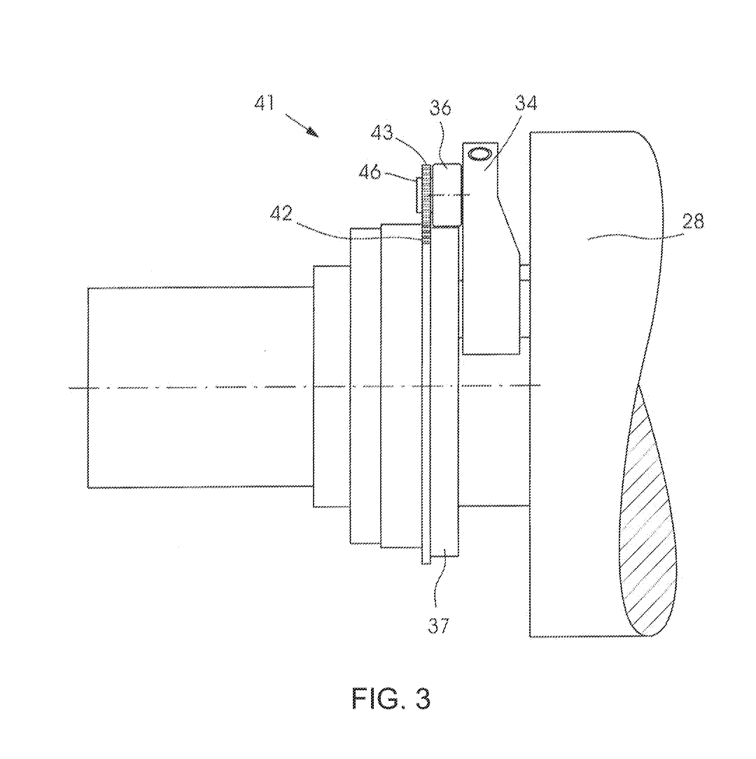

In order to ensure that the control roller 36 always rolls on the control cam 37 without slippage, provision is made for both the control cam 37 and the control roller 36 to each be assigned a respective toothing system 42, 43 with the same tooth modulus. In this case, a pitch circle of the toothing systems 42, 43 preferably lies at the height of the contour of the control cam 37. The toothing systems can, for example, be gear wheels or toothed rings, which are disposed on respective hubs 44, 46 of the control cam 37 and the control roller 36, as seen in FIGS. 2 and 3. Elements 42, 43 thus each form an anti-twist device.

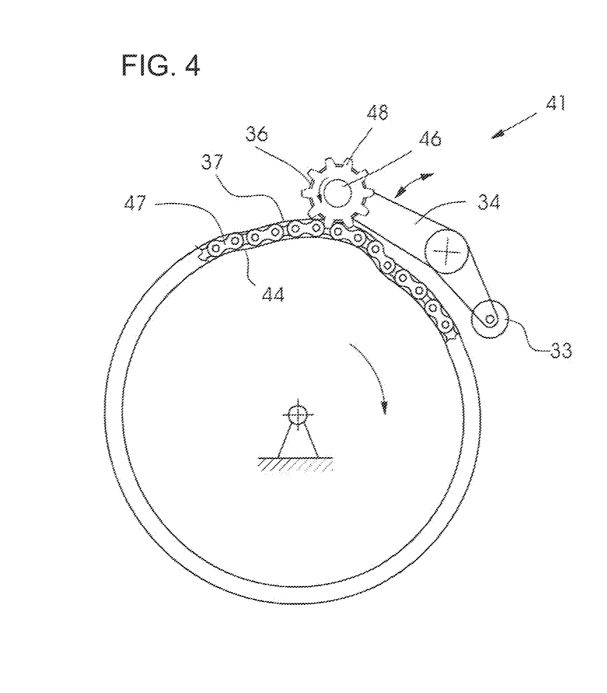

In an exemplary embodiment according to FIG. 4, provision is made for a chain 47 to be disposed on the hub 44 of the control cam 37 and to mesh with a sprocket 48 disposed axially parallel to the control roller 36.

In this case, the number of engagement points of the chain 47 is an integer multiple of the teeth of the sprocket 48. Elements 47, 48 thus each form an anti-twist device.

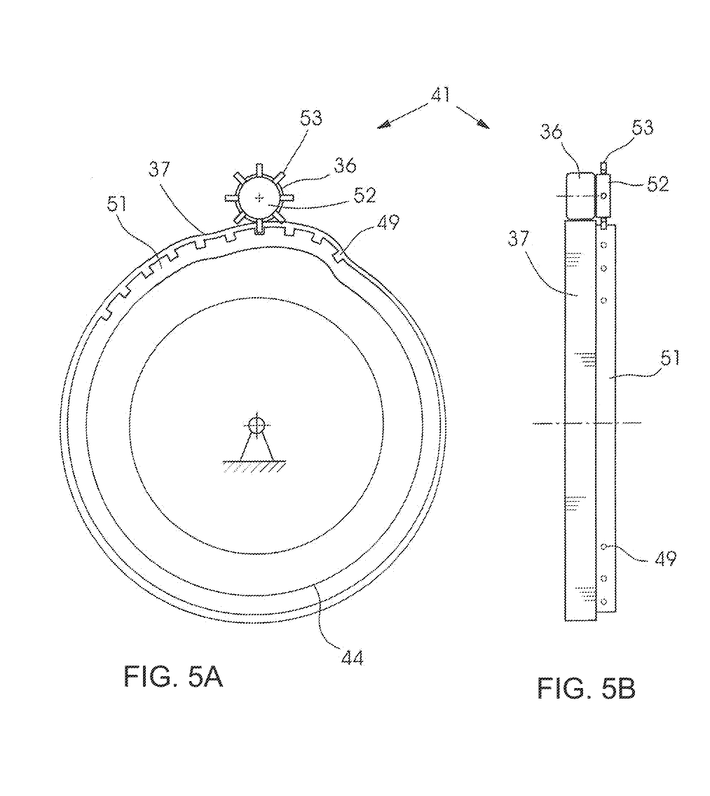

In an exemplary embodiment according to FIGS. 5A and 5B, provision is made for the control cam 37 to be assigned a cam element 51 matched to the contour of the control cam 37 and having engagement points 49 (for example drilled holes) on the hub 44. Of course, the drilled holes 49 can also be introduced directly into the hub 44.

A pin wheel 52 is assigned axially parallel to the control roller 36 in such a way that pins 53, for example bolts, engage in the drilled holes 49 in the cam element 51. The number of drilled holes 49 in the cam element 51 is an integer multiple of the number of bolts 53 on the pin wheel 52. Elements 51, 52 thus each form an anti-twist device.

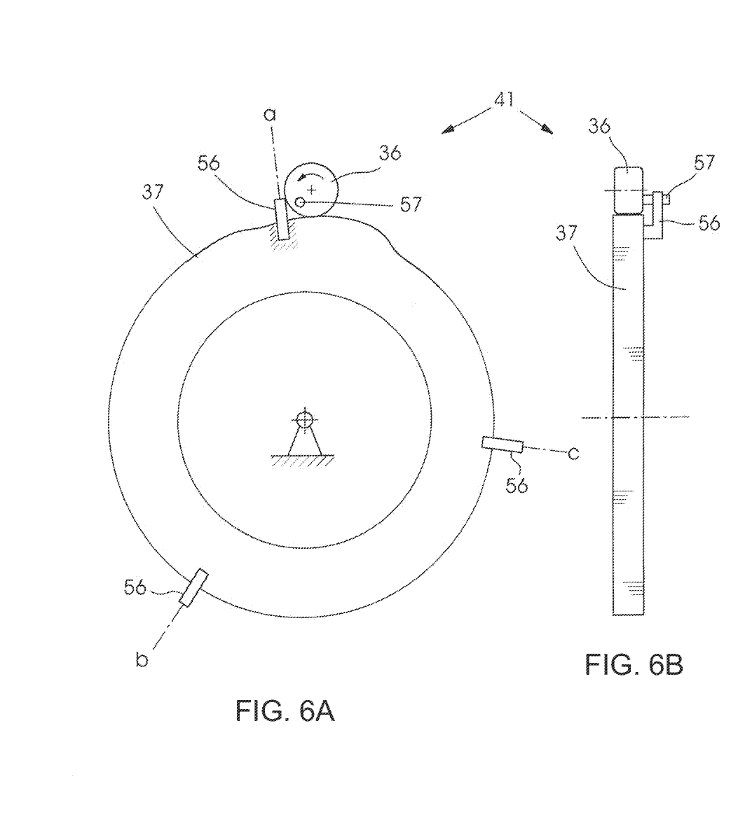

In an exemplary embodiment according to FIGS. 6A and 6B, provision is made for the control cam 37 to be assigned stops 56 only in the area of functional points a and to serve to calibrate the control roller 36 in relation to control cam 37. A driver 57, which is fixed to the control roller 36, comes into contact with the stop 56 of the control cam at the respective functional points a and if necessary rotates the control roller 36 so far as to come into a position defined by the stop 56 and the driver 57. Elements 56, 57 thus each form an anti-twist device.

All of the exemplary embodiments relate to a control cam which is disposed in such a way as to be stationary. However, the invention can also be applied to control cams that can be driven in rotation.

1. A cam mechanism, comprising:
a control cam; and
a control roller rolling on said control cam to produce a deflection of said control roller;
said control cam and said control roller each having a respective anti-twist device interacting with each other.

2. The cam mechanism according to claim 1, wherein said control cam has a contour, and said anti-twist device includes a toothed ring matched to said contour of said control cam and a gear wheel disposed axially parallel to said control roller and in toothed engagement with said toothed ring.

3. The cam mechanism according to claim 1, wherein said control cam has a contour, and said anti-twist device includes a chain matched to said contour of said control cam and a sprocket disposed axially parallel to said control roller and in engagement with said chain.

4. The cam mechanism according to claim 1, wherein said control cam has a contour, and said anti-twist device includes a cam element matched to said contour of said control cam and having drilled holes formed in said cam element and a pin wheel disposed axially parallel to said control roller and in engagement with said drilled holes.

5. The cam mechanism according to claim 1, wherein said anti-twist device includes a stop disposed on said control cam and a driver disposed on said control roller and in operative contact with said stop.

6. The cam mechanism according to claim 2, wherein said toothed ring is disposed on a hub of a cylinder.

7. The cam mechanism according to claim 3, wherein said chain is disposed on a hub of a cylinder.

8. The cam mechanism according to claim 4, wherein said cam element is disposed on a hub of a cylinder.

9. An alignment cylinder for sheets, the alignment cylinder comprising a cam mechanism according to claim 1.

10. A sheet processing machine, comprising an alignment cylinder having a cam mechanism according to claim 1.
